(19) United States
(12) Patent Application Publication
(10) Pub. No.: US 2017/0335875 A1
(43) Pub. Date: Nov. 23, 2017

(54) INSERT DESIGNED TO BE INCLUDED IN A PART MOULDED BY INJECTION AND MOULDED PART COMPRISING ONE SUCH INSERT

(71) Applicant: BOLLHOFF OTALU s.a., La Ravoire (FR)

(72) Inventor: Patrick LEJARS, Barraux (FR)

(73) Assignee: BOLLHOFF OTALU s.a., La Ravoire (FR)

(21) Appl. No.: 15/159,996

(22) Filed: May 20, 2016

(51) Int. Cl. F16B 13/00

(52) U.S. Cl. CPC F16B 13/00

(57) ABSTRACT

Insert designed to be included in a part moulded by injection, comprising a body extending along a longitudinal axis of the insert, and a base situated at one end of the body and provided with at least one plate comprising at least one pass-through opening, at least one pass-through opening of the base being oriented in an inclined direction with respect to the longitudinal axis of the insert.

### BACKGROUND OF THE INVENTION

The invention relates to inserts designed to be included in a part moulded by injection.

### STATE OF THE ART

In general manner, an insert designed to be included in a part moulded by injection, also called insert to be moulded from casting, can be a nut, a rivet, a screw or a gudgeon-pin, or of any form or shape depending on its function. The inserts included in a moulded part have to be suitable to resist tensile and pressure forces so as to guarantee a good strength of the mechanical link between the moulded part in which they are included and another part which is to be fixed to the moulded part.

In FIGS. 1 to 3, a rivet 1 of the prior art has been represented in schematic manner. In FIG. 1, a top view of the rivet 1 has been represented. In FIG. 2, a top view of the rivet 1 has been represented in a laminar flux of a resin 2 used to manufacture a moulded part 3. In FIG. 3, a cross-sectional view of the rivet 1 included in the moulded part 3 has been represented. The rivet 1 represented in FIGS. 1 to 3 comprises a hollow body 4, such as a shank, extending along a longitudinal axis A of the rivet 1, and a base 5 welded to one end of the body 4. The base 5 is in the form of a circular plate. Furthermore, the base 5 is perforated, i.e. it comprises several pass-through circular openings 6 arranged in regular manner on the base 5. Such a rivet 1 is integrated in the moulded part 3 by injecting a resin on the rivet 1 so as to sink the base 5 in the resin to mechanically secure the rivet 1 to the part 3 when the resin hardens. In general, the resin is a hardenable fluid material made from polyester and glass fibers. But these rivets do not provide a sufficient strength in the part moulded by injection. In particular, when the rivet is made from a different material from that of the resin, for example a steel rivet, the strength of composite materials is difficult to obtain.

To manufacture the moulded part 3, the resin is in fact injected by creating the laminar flux of the resin 2 along the surfaces of the perforated base 5. Furthermore, the circular openings 6 of the base 5 are designed to let resin fibers penetrate so as to create reinforcement fibers 7 through the circular openings 6. But the penetration of the resin into the circular openings 6 is random, and in this case the reinforcement fibers 7 are not distributed sufficiently around the base 5. The rivet 1 is then badly anchored in the moulded part 3. Furthermore, when injection of the resin is performed, the flow of the flux 2 is disturbed by the body 4 of the rivet 1. This disturbance generates a vortex 8 in the region situated to the rear of the body 4, i.e. opposite the point of the impact between the flow of the flux 2 and the body 4. The vortex 8 disturbs the flow of the flux 2 in the region and creates inclusions 9 of vacuum or air in the resin, represented in FIG. 2 by hatched ellipses, which weakens the structure of the assembly comprising the moulded part 3 and the rivet 1. In particular, such inclusions 9 are not always detectable and constitute a threat for the integrity of the assembly which, in time, may crack seriously around the rivet 1, or even break.

Finally, certain moulded parts may have complex shapes comprising one or more curves, in particular curves located in the proximity of the insert, and the inserts have to be able to be placed at the level of these curves while at the same time giving the assembly a good mechanical strength.

### OBJECT OF THE INVENTION

The object of the invention consists in providing an insert designed to be included in a part moulded by injection which enables the above-mentioned shortcomings to be palliated, and in particular which gives the insert a better strength in the part.

Another object consists in providing an insert suitable for the complex shapes of the parts moulded by injection and which guarantees an efficient strength.

Another object of the invention consists in providing a moulded part provided with an insert that is robust.

According to one feature of the invention, an insert designed to be included in a part moulded by injection is proposed comprising a body extending along a longitudinal axis of the insert and a base situated at one end of the body and provided with at least one plate comprising at least one pass-through opening and extending along a secondary axis perpendicular to the longitudinal axis.

At least one pass-through opening of the base is oriented in a direction that is inclined with respect to the longitudinal axis of the insert and inclined with respect to the secondary axis.

Penetration of the reinforcing fibers when injection of the resin is thus enhanced. The penetration of the reinforcing fibers is particularly improved when the direction of orientation of the pass-through opening or openings is inclined towards the direction of the laminar flux of the resin. An insert is thus provided which improves the distribution of the reinforcing fibers.

The base can comprise several pass-through openings oriented in a same direction inclined with respect to the longitudinal axis of the insert and inclined with respect to the secondary axis.

At least one plate of the base can have an undulated or notched shape.

Such a plate enables the base to be folded in order to be able to integrate the insert in parts having complex shapes. For example the part may present a curve close to the insert. In other words, the space allocated for the base may be limited and the base might have to be folded to follow the shape of the curves of the part.

The base can comprise several plates superposed on one another.

Two superposed plates can comprise first parts respectively separated from one another and second parts respectively joined to one another.

By means of the first parts separated from one another, resin flux rectification areas can be created between the superposed plates, and the dissipation by friction of the mechanical energy of the resin when flow takes place can be reduced.

Pass-through openings of a plate can coincide respectively with pass-through openings of another superposed plate.

Pass-through openings of a plate can be staggered with respect to pass-through openings of another superposed plate.

Each pass-through opening can have a cross-section having the shape of a quadrilateral.

Each pass-through opening can have a cross-section having the shape of a rhombus, and the larger diagonals of the cross-sections of the pass-through openings are parallel to one another.

According to one embodiment, the body of the insert has a cross-section having an elliptical or oval shape.

The degradation effects of a vortex during the injection phase of the resin are thus limited. Such an insert can be a rivet or a nut.

According to another embodiment, the body of the insert comprises a first section having a cross-section with a circular external profile and a second section situated between the first section and the base, the second section having a cross-section with an external profile which is elliptical or oval. Such an insert can be a rivet, a nut, and preferably a screw or a gudgeon-pin.

Each plate can be fixed to the body of the insert by crimping.

According to another feature of the invention, a part moulded by injection is proposed comprising the insert as defined in the foregoing.

### BRIEF DESCRIPTION OF THE DRAWINGS

Other advantages and features of the invention will become clearly apparent from examination of the detailed description of non-restrictive embodiments and of the appended drawings in which:

FIGS. 1 and 2 schematically illustrate two top views of a rivet according to the prior art;

FIG. 3 schematically illustrates a cross-sectional view of the rivet of FIGS. 1 and 2;

FIG. 4 schematically illustrates a top view of an embodiment of an insert according to the invention;

FIG. 5 schematically illustrates a cross-sectional view along the line A-A of the insert of FIG. 4 included in a moulded part;

FIG. 6 schematically illustrates a perspective side view of the insert of FIG. 4;

FIG. 7 schematically illustrates a perspective view of another embodiment of an insert according to the invention;

FIG. 8 schematically illustrates a detail of a cross-sectional view along the line B-B of the insert of FIG. 7; and

FIG. 9 schematically illustrates a cross-sectional view of another embodiment of an insert according to the invention.

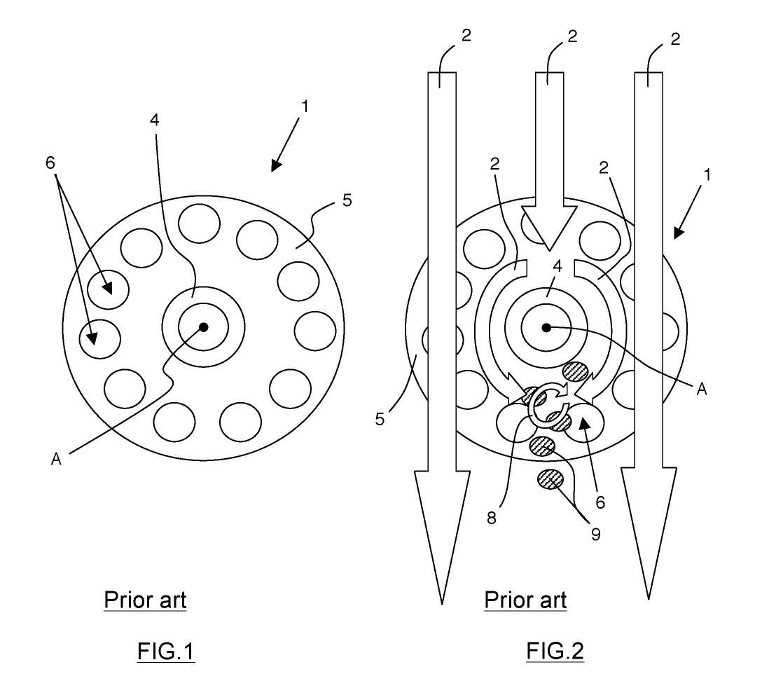

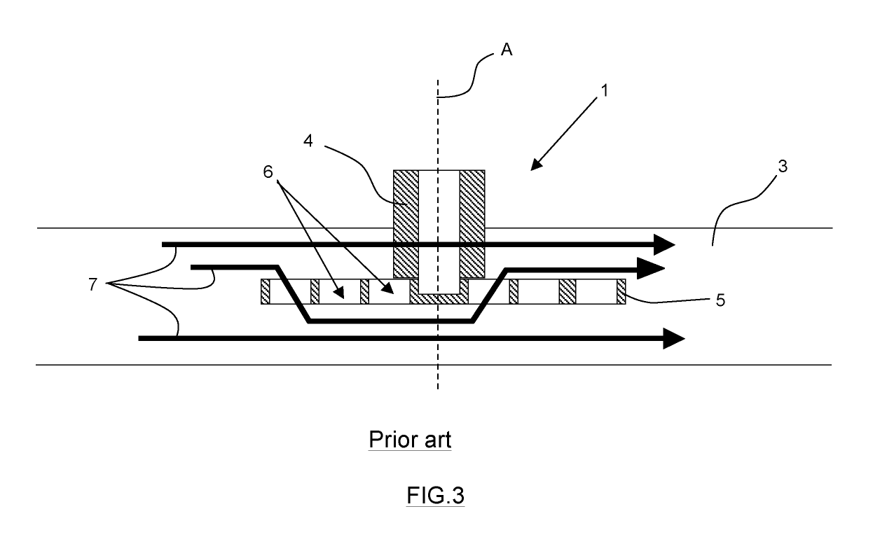

### DETAILED DESCRIPTION

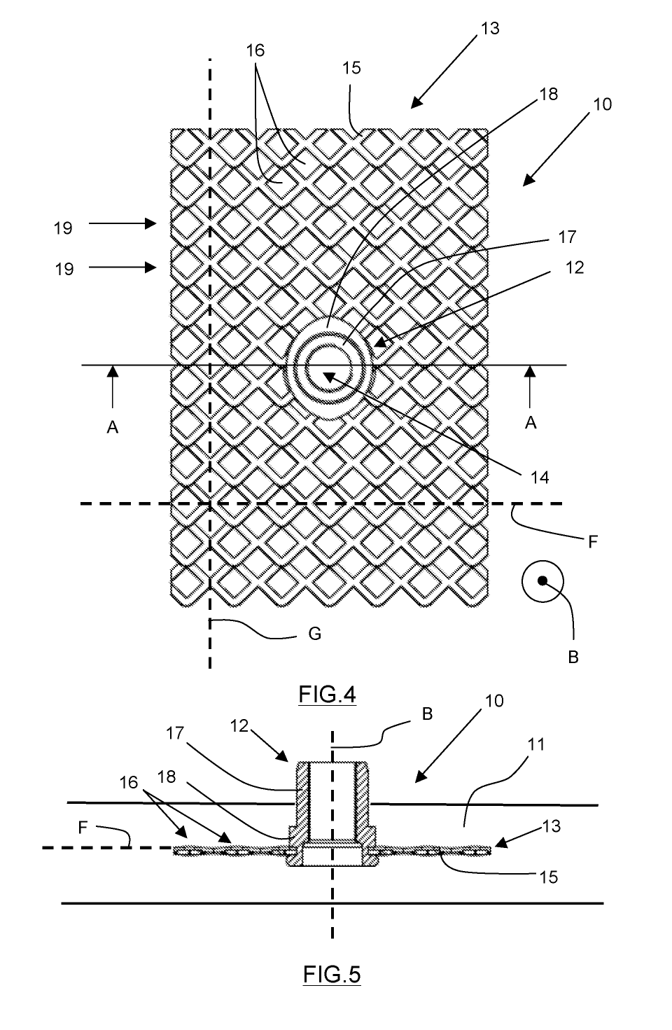

In FIGS. 4 to 6, an insert 10 has been represented designed to be included in a part 11 moulded by injection, which is for its part illustrated in FIG. 5. FIG. 6 is a side view of the right-hand side of the insert 10 of FIG. 4. The insert 10 can be a nut, a rivet, a screw or a gudgeon-pin. A nut is a tapped hollow part, i.e. it comprises an internal thread, designed to be secured to another threaded part. A rivet is an assembly element of flat parts swollen at one end, the other end of which has been crushed. A screw or gudgeon-pin is a threaded solid part, i.e. it comprises an external thread. Preferentially, the insert 10 is made from metal, for example from steel. The insert 10 comprises a body 12, such as a shank, extending along a longitudinal axis B of the insert 10, and a base 13 located at a first end of the body 12. The body 12 of the insert 10 has a globally cylindrical shape. What is meant here by cylinder is a solid limited by a cylindrical surface generated by a straight line, called generating line, following the path of a closed flat curve, called base line, and two parallel planes cutting the generating lines. Preferably the body 12 has a shape of a hollow cylinder provided with an opening 14 which may be pass-through or blind. The body 12 can further have an external surface which presents several axial faces so as to present flat surfaces as anti-rotation means of the insert 10 in the moulded part 11. The first end is preferentially closed to form, in particular, a blind hollow insert, or a solid insert, in order to prevent the resin from penetrating into the body 12.

The base 13 comprises at least one plate 15 provided with at least one pass-through opening 16. Such a plate 15 enables the strength of the insert 10 in the moulded part 11 to be increased when strong resistances are required. The plate 15 can have a circular, rectangular or square shape. It can comprise several pass-through openings 16, and for example pass-through openings 16 arranged in regular manner on the base 13. Preferably, the pass-through openings 16 are oriented in a same direction D inclined with respect to the longitudinal axis B of the insert 10. What is meant by inclined is the fact that each direction D forms a non-zero angle E with a parallel B′ to the longitudinal axis B. In particular the angle E is greater than 0° and smaller than 90°. Preferentially, the angle E is greater than 0° and smaller than or equal to 45° so as to orient the pass-through openings 16 in the direction of the laminar flux of resin 2. Indeed, the pass-through openings 16 each have a longitudinal axis D oriented in a direction which passes through the opening, the longitudinal axis D of the opening corresponding to the direction of orientation of the opening. When the longitudinal axes D of the openings are inclined in the direction of the laminar flux of resin 2, penetration of the resin in the pass-through openings 16 is enhanced and the distribution of the reinforcing fibres around the base 13 is thus improved. Preferentially, the pass-through openings 16 each have a direction D inclined with respect to the longitudinal axis B of the insert 10. For example the angles E of the directions D with the longitudinal axis B can be different from one another. Furthermore, the plate 15 extends along a secondary axis G. The secondary axis G is perpendicular to the longitudinal axis B. At least one pass-through opening 16 is oriented according to an inclined direction D with respect to the secondary axis G. Preferably, the pass-through openings 16 each have an inclined direction D with respect to the secondary axis G.

An incline of the directions D of the pass-through openings 16 is obtained for example using a notched or undulated plate 15. The incline of the directions D of the pass-through openings 16 thus produces a deflection of the flux path of the resin 2, i.e. it modifies the direction of flow of the resin facilitating passage of the resin in the pass-through openings 16 so as to create reinforcing fibers. The pass-through openings 16 in general manner have a cross-section having the shape of a polygon, for example a hexagon, preferably a cross-section having the shape of a quadrilateral to lighten the plate which comprises less material in comparison with a circular opening having a diameter equal to the width of the quadrilateral. For example, the pass-through openings 16 have a cross-section having the shape of a rhombus, and the large diagonals of the cross-sections of the pass-through openings 16 are parallel to one another. A homogenous arrangement of the pass-through openings 16 is thus obtained, which improves the distribution of the reinforcing fibres. In FIG. 5, it can be noted that the plate 15 is undulated along a main axis F of the plate 15 which is perpendicular to the longitudinal axis B of the insert 10. In FIG. 6, it can be noted that the plate 15 is notched along the secondary axis G of the plate 15 which is perpendicular to the longitudinal axis B of the insert 10 and to the main axis F. What is meant by notched is the fact that the plate 15 comprises several lines 19 of pass-through openings 16 in which the pass-through openings 16 are aligned along the main axis F, and the lines 19 of pass-through openings 16 overlap to incline the pass-through openings 16 with respect to the longitudinal axis B. The insert 10 described in FIGS. 4 to 6 has an undulated and notched shape respectively along both axes, the main axis F and secondary axis G. As a variant, the plate 15 is either notched or undulated only along the secondary axis G which is designed to be oriented in the direction of the laminar flux 2.

Furthermore, according to a first embodiment, the body 12 of the insert 10 has a cross-section having an elliptical or oval shape so as to obtain a better flow coefficient of the resin during the moulding operation of the part 11. The elliptical shape enhances sliding of the laminar flux of the resin 2, and more particularly it enables the flux 2 flowing on the sides of the body 12 of the insert 10 to join one another in the area at the rear of the body 12 without imprisoning air bubbles. In particular, the outer surface of the body 2 has an elliptical shape, so the inside of the body 12 can be circular so as to provide a nut or a rivet. According to a second embodiment, the body 12 comprises a first section 17 having a cross-section with a circular external profile and a second section 18 situated between the first section 17 and the base 13. The second section 18 has a cross-section with an elliptical or oval external profile to reduce cavitation phenomena. In the second embodiment, the first section 17 has a circular external surface to provide a screw or a gudgeon-pin. Preferentially, the large axis of the elliptical shape of the body 12 is oriented in the direction of the laminar flux 2.

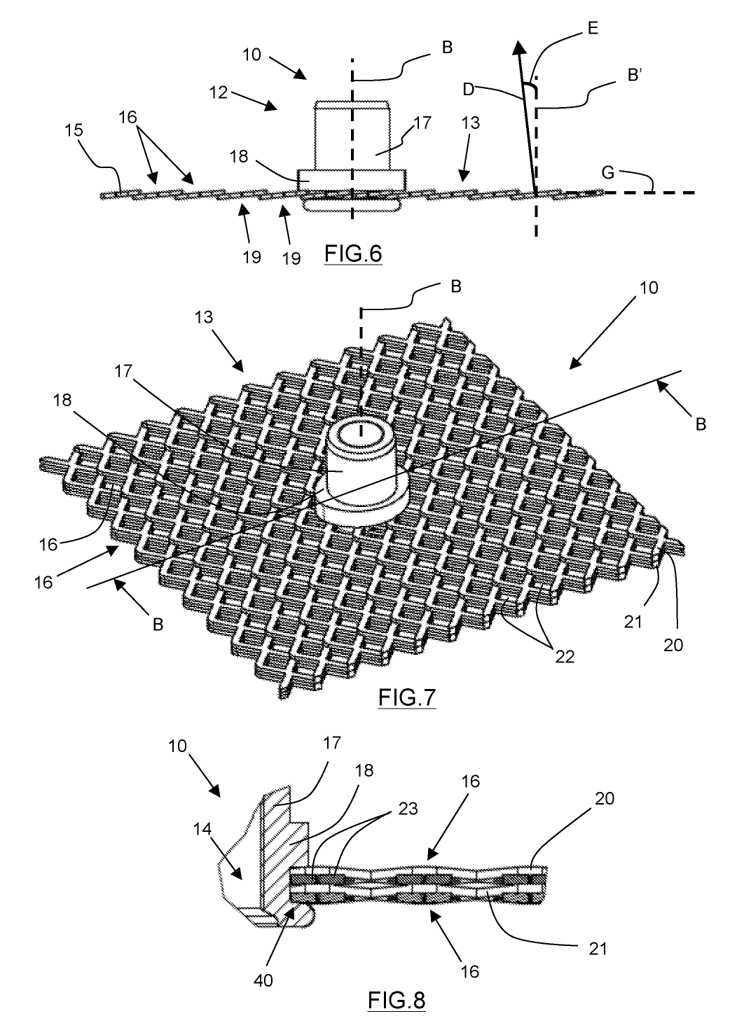

In FIGS. 7 and 8, an insert 10 has been represented the base 13 of which comprises two superposed plates 20, 21. As a variant, the base 13 can comprise several superposed plates. Each plate comprises pass-through openings 16 the direction of orientation D of which is inclined with respect to the longitudinal axis B of the insert 10. For example, each plate comprises pass-through openings 16 the orientation direction of which is inclined with respect to the secondary axis G of the plate. In particular, the plates 20, 21 are superposed so that pass-through openings 16 of a plate 20 coincide respectively with pass-through openings 16 of another superposed plate 21. As a variant, pass-through openings 16 of a plate 20 can be staggered with respect to pass-through openings 16 of another superposed plate 21. The pass-through openings 16 which coincide with one another form a channel 22 passing through the base 13. So that the pass-through openings 16 coincide with one another, the plates 20, 21 have the same shape. Such a channel 22 has a longitudinal axis having a direction which passes through the channel 22 and which is inclined with respect to the longitudinal axis B of the insert. Linking of the superposed plates 20, 21 to one another can be achieved by fixing the plates 20, 21 to the insert 10. In this case, the insert 10 comprises a body having a fixing section, for example the second section 18, provided with a notch 40 located on the external periphery of the fixing section 18 and which enables the plates 20, 21 to be pinched to secure them in their superposed position. For example, the superposed plates 20, 21 are fixed to the second section 18 of the body 12 by crimping. In other words, the superposed plates 20, 21 are inserted in the notch 40 of the second section 18, and the second section 18 is deformed to crimp the superposed plates 20, 21 to the body 12 of the insert 10. As a variant, the insert 10 can comprise a washer located between one of the superposed plates 20, 21 and one end of the notch 40 of the second section 18 in order to increase the pinching of the plate. The link can also be achieved by staple fasteners on the edge of the superposed plates 20, 21, or again by welding spots 23. The use of at least two superposed plates 20, 21 enables the reinforcing fibres which intertwine between the plates 20, 21 to be increased, which enhances the tensile, shear or flexural strength of the insert 10.

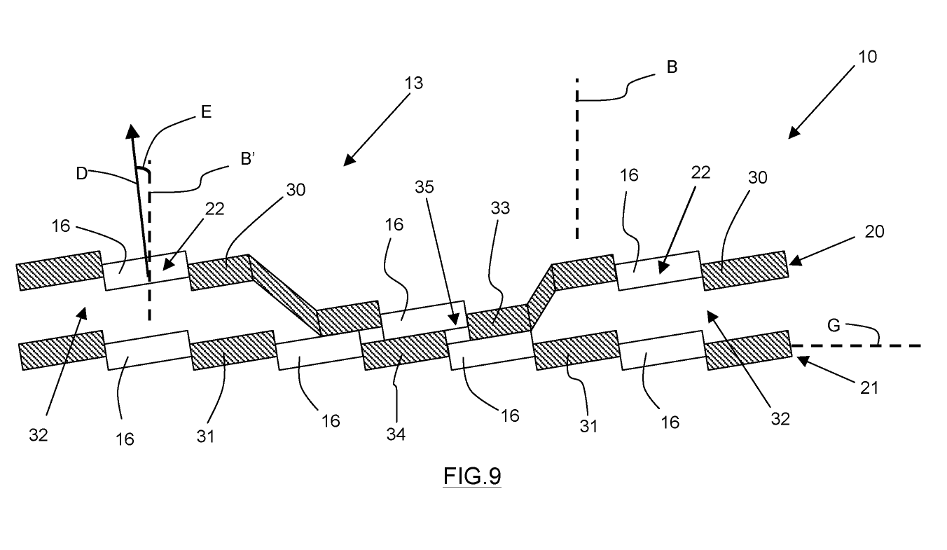

In FIG. 9, another embodiment of an insert 10 with a base 13 comprising two superposed plates 20, 21 has been represented. According to this other embodiment, the superposed plates 20, 21 comprise first parts 30, 31 respectively separated from one another. Two first parts 30, 31 are facing one another and form a space 32 for penetration of the resin between the superposed plates 20, 21. The superposed plates 20, 21 can further comprise second parts 33, 34 respectively joined to one another. In these first parts 30, 31 and second parts 33, 34, the pass-through openings 16 of a plate 21 can either coincide respectively with pass-through openings 16 of another superposed plate 21 and form first pass-through channels 22, or be staggered with respect to the pass-through openings 16 of another superposed plate 21 to form second pass-through channels 35. For example, as illustrated in FIG. 9, the pass-through openings 16 situated in the first parts 30, 31 of the superposed plates 20, 21 coincide with one another and form first pass-through channels 22. Other pass-through openings 16 situated in the second parts 33, 34 of the superposed plates 20, 21 are staggered from one another and form second pass-through channels 35 which are narrower than the first pass-through channels 22.

Such an insert enables assembly of an element on a part made from a thermosetting or thermoplastic composite material, and more particularly for a material reinforced with fibers made from glass, carbon, aramid, ceramic, etc. The insert is particularly suitable for the automobile industry and can also be used in the naval sector or in that of aeronautics.

1. An insert designed to be included in a part moulded by injection, comprising a body extending along a longitudinal axis of the insert, and a base situated at one end of the body and provided with at least one plate comprising at least one pass-through opening and extending along a secondary axis perpendicular to the longitudinal axis, wherein at least one pass-through opening of the base is oriented in a direction that is inclined with respect to the longitudinal axis of the insert and inclined with respect to the secondary axis.

2. The insert according to claim 1, wherein the base comprises several pass-through openings oriented in a same direction inclined with respect to the longitudinal axis of the insert and inclined with respect to the secondary axis.

3. The insert according to claim 1, wherein at least one plate of the base has an undulated or notched shape.

4. The insert according to claim 1, wherein the base comprises several plates superposed on one another.

5. The insert according to claim 4, wherein two superposed plates comprise first parts respectively separated from one another and second parts respectively joined to one another.

6. The insert according to claim 4, wherein pass-through openings of a plate coincide respectively with pass-through openings of another superposed plate.

7. The insert according to claim 4, wherein pass-through openings of a plate are staggered with respect to pass-through openings of another superposed plate.

8. The insert according to claim 1, wherein each pass-through opening has a cross-section having the shape of a quadrilateral.

9. The insert according to claim 1, wherein each pass-through opening has a cross-section having the shape of a rhombus, and the larger diagonals of the cross-sections of the pass-through openings are parallel to one another.

10. The insert according to claim 1, wherein the body of the insert has a cross-section having an elliptical or oval shape.

11. The insert according to claim 1, wherein the body of the insert comprises a first section having a cross-section with a circular external profile and a second section situated between the first section and the base, the second section having a cross-section with an external profile which is elliptical or oval.

12. The insert according to claim 1, wherein each plate is fixed to the body of the insert by crimping.

13. A part moulded by injection, comprising the insert according to claim 1.
